(19) United States
(12) Patent Application Publication
(10) Pub. No.: US 2002/0140386 A1
(43) Pub. Date: Oct. 3, 2002

(54) Torque control for rotating sign drive

(76) Inventors: William A. Becklin, Stanchfield, MN (US); Gary D. Pangerl, Braham, MN (US)

Correspondence Address: WESTMAN, CHAMPLIN & KELLY, SUITE 1600 - INTERNATIONAL CENTRE, 900 SECOND AVENUE SOUTH, MINNEAPOLIS, MN, 55402-3319, US

(21) Appl. No.: 09/823,291

(22) Filed: Mar. 30, 2001

(51) Int. Cl. H02P 7/00; H02K 17/32; H02K 23/68; H02K 27/30

(52) U.S. Cl. 318/434

(57) ABSTRACT

A sign that has rotating elements that present various faces to viewers, is driven by a motor that will rotate the sign elements. The motor is controlled so that the operating current of the motor in a normal operating cycle is sensed, and a reversing set point circuit limit is adjusted as a function of the current sensed to provide for a changeable set point limit that is related to the operating current needed up to a maximum current level.

### BACKGROUND OF THE INVENTION

The present invention relates to a drive for a changeable sign which has a plurality of rotatable sign elements that have three faces arranged in a triangular cross section, and wherein the sign elements are driven so that a number of the elements will be aligned side-by-side with the faces displaying a sign. The sign elements can be rotated to present three different signs. A drive motor is provided with an adjustable motor drive current limit level that will adjust the level of the current limit at which reversal of the motor will occur, either up or down, but never over a predetermined maximum current each time the motor is energized.

Various triangular sign elements that rotate to present three different signs have been advanced. Some of the signs utilize chain or belt drives, so that each of three different signs can be presented for viewing. The gear reduction used will rotate each of the sign elements 120° for each revolution of the drive motor.

When multiple side-by-side rotating sign elements are provided, a control has been provided so that the sign elements will be reversed if something jams in-between the elements, or if some other external factor causes the drive torque of the motor to become excessive.

It has been well known to provide an operating current limit for the drive motors for such signs, at which motor current level the sign elements will be reversed, so that if a foreign object is thrust between the rotating sign elements, the motor operating or drive current will be sensed and if at or above the limit for a present time the sign elements will reverse to permit clearing or the like.

Additionally, sequencing controls have been provided so that the sign element motor will attempt to rotate the sign elements forwardly, but two reversals in a row results in the motor shutting off completely. In some instances, shutting off the motor can occur immediately, upon sensing a particular condition, such as maximum over current limit being exceeded in both the forward and reverse directions of drive.

The reversing or stopping of the motor can trigger suitable indicators that indicate a malfunction has occurred. This is conventionally done.

### SUMMARY OF THE INVENTION

The present invention relates to a control for drive motors on rotating sign elements for a sign that has a plurality of sign elements that are rotated incrementally to present different sign messages to a viewer, in which the operating current limit for the motor, before reversing the motor is required or initiated, can be adjusted to be at a desired range above the normal expected drive or operating current. This permits the level of the operating current limit to be adjusted upwardly or downwardly to accommodate changing load conditions, such as buildup of materials in bearings, wear, or the like where it may take a higher or lower current for the motor in order to drive the sign elements, but yet no condition exists which would require reversing the motor and sign elements.

A maximum current (never exceed) limit setting is also used as done in the prior art, so that the drive current will not exceed that maximum. If the adjustable operating current limit set point is such as to be greater than the maximum current limit, then any time the maximum current was reached the motor would reverse.

The adjustable operating current limit set point at which current the motor is reversed is used in connection with a current sensing circuit that will sense the operating or drive current after the motor has ramped up to an operating speed, and this current sensing circuit then in effect determines the torque being provided by the motor. Setting the adjustable set point for reversal between 10% and 50% greater than the normal operating current can be done very easily. Normally the level of the operating current limit as a percentage over the expected operating current can be adjusted at the factory, or by the operator. The adjustable set point then is automatically reset proportionally each time the motor is energized, that is, at the start of each cycle of rotational movement of the sign elements, and then a new set point or limit is set the next time the motor starts.

The current settings can be provided with separate known circuitry, or in a microprocessor, with the operating or drive current sensed being an input that would initiate the dynamic set point adjustments. The other settings such as maximum current, can be provided by suitable programming, as is now done.

### BRIEF DESCRIPTION OF THE DRAWINGS

FIG. 1 is a schematic representation of a typical prism type sign having rotating sign elements;

FIG. 2 is a top plan view of the device of FIG. 1 with parts removed;

FIG. 3 is a schematic block diagram of a control circuit accomplishing the adjustable torque setting of the present invention; and

FIG. 4 is a graph plotted as motor operating current versus time, with the operating current set points or limits illustrated, along with the maximum current limit.

### DETAILED DESCRIPTION OF THE PREFERRED EMBODIMENTS

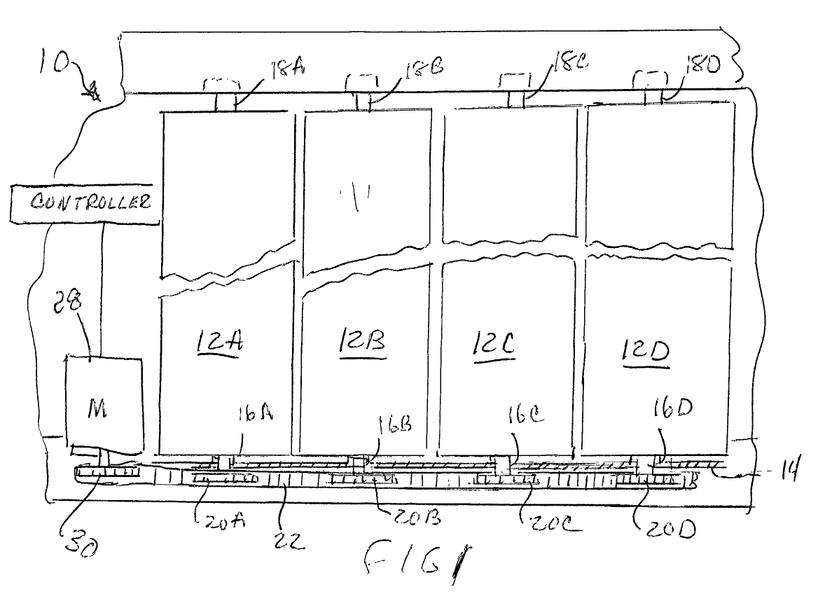

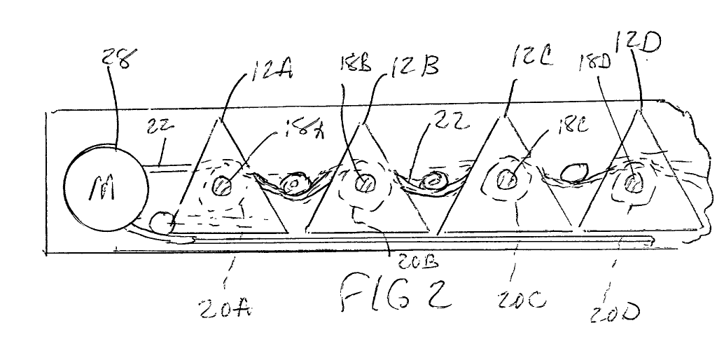

Referring to FIG. 1, a schematic showing of a multiple element sign is indicated at 10, and it includes a plurality of triangular shaped sign elements 12A, 12B, 12C and 12D that are mounted for rotation about generally upright axes. More than four sign elements are used in an actual sign.

A bearing support 14 can be used at the end, for supporting shafts 16A, 16B, 16C and 16D, of the sign elements. The upper ends of the sign elements shafts shown at 18A, 18B, 18C and 18D which rotatably mounted in an upper housing. The sign elements are rotated by sprockets shown schematically at 20A, 20B, 20C and 20D on the shafts 16A, 16B, 16C and 16D. These sprockets are driven by a chain 22 that drive all the sprockets simultaneously. The chain drive can be one continuous chain wrapped around the sprockets, or chains going from one element to the other can be used.

The chain 22 is driven from a drive motor 28, that can have a gear reduction box that has an output shaft driving a suitable drive sprocket 30.

The motor 28 can be any suitable reversible motor, usually a DC motor or a stepper motor that can be adjusted in speed from a motor controller, to accommodate the size of the sign elements. A dwell time between movements of the cams to index the sign members 120° for each revolution of a motor is also provided.

Conventionally, the motor control is made so that if the current that the motor draws exceeds a maximum, the motor controller will reverse the motor 28. Thus, if an object comes between two of the sign elements when the sign elements are being indexed in their “forward” direction, the motor will reverse and permit the foreign object to fall out or to be removed. The motor is reversed until it reaches its previous rest or stopped position and the program controls the motor so the motor will again be energized to try to rotate in its first direction or forward direction. If the sign elements encounter an obstacle on the second try, so the motor current exceeds the operating current limit, the motor will again reverse. A counter is used for counting the number of times that the motor reverses and then driven forward, and if it reverses more than two times in a row, the motor will be shut down indicating that there is a serious malfunction of the sign or there is some permanent obstruction that needs to be removed. That feature of reversal, counting and shutting down is prior art.

The level of the current drawn by the motor that will cause reversing is set to be less than the maximum current, for good operational parameters. The present invention is to adjust that operating current limit to correspond to changing levels in the actual operating current. The normal motor operating current that is needed for a new sign is generally less than that which is needed as a sign has been used. Use may cause wear on the bearings or mountings, and perhaps wear on the drive that rotate the sign. More or less power or output torque may be needed at different times to rotate the sign during its normal operation. It is thus desirable to also raise or lower the level of the current limit at which the motor will be reversed a proportional amount. The current limit adjustment permits an adjustable operating torque level to be achieved before reversing the sign elements, up to the maximum current limit allowed, which is a “never exceed” current and would provide a shutdown that would require servicing.

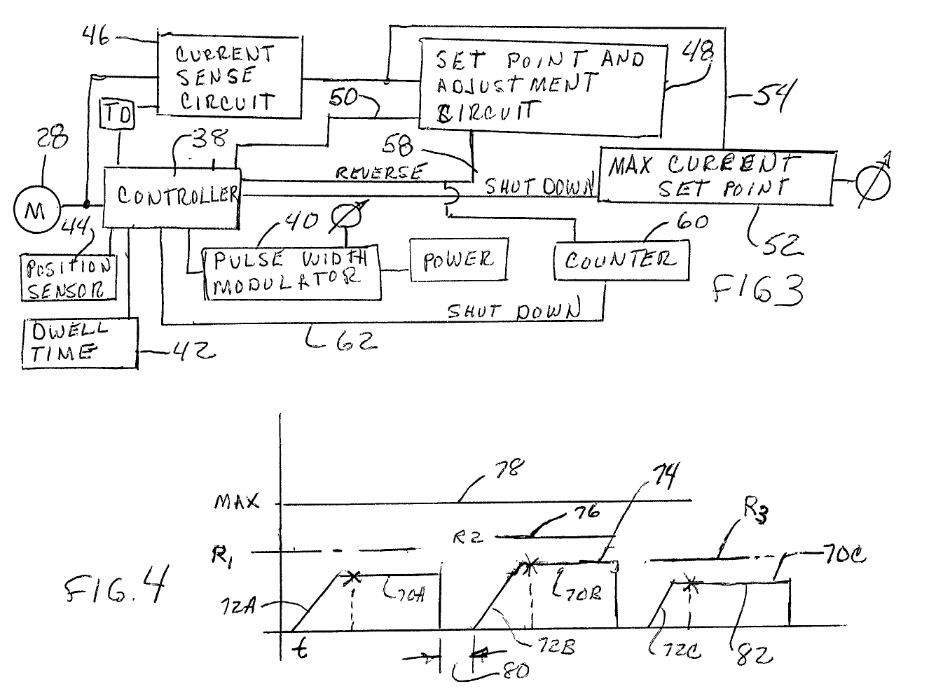

The concept of an automatic torque control for rotating signs is implemented in a number of ways, and referring to FIG. 3, a schematic block diagram is shown and in FIG. 4 a graphical representation of current level is provided.

The motor 28 is controlled by a controller 38, which can be a microprocessor, or other type of controller as desired. The normal operation of the motor 28 through the controller 38 is to drive the motor with a series of electrical pulses from a pulse width modulator 40, that is energized in a suitable manner. Pulse width modulator 40 can be adjusted so that the duty cycle of the pulses can be anywhere between 10% to 100% or full on. This power is provided through the controller 38 to the motor. The controller 38 also has other settings, such as the “dwell time” set circuit 42 which sets the different length of time that each display surface of the sign elements are stationary for viewing before the motor starts again, and a position sensor 44 that actually senses the correct positions of the sign elements. This sensor can be provided to insure that the sign elements reach their correct position before the drive motor is turned off. Generally speaking the drive motor is driven one revolution to rotate the sign elements 120°.

A conventional current sensing circuit or sensor 46 is connected to the motor circuit on the output side of the controller 38 to sense the current that is being drawn by the motor 28 a short time after the motor reaches its operating speed. For example, 0.1 second after allowing the motor to ramp up to speed, which usually takes about 0.5 seconds. This current signal as sensed is provided to an adjustable set point circuit indicated at 48. This can be a potentiometer, FET circuitry, adjustable comparators, or similar devices that will provide a reference level of current against which the current sensed is compared. The set point is this reference level or limit, and as long as the current from the current sensor is less than the reference level, a signal to the controller provided along a line 50 indicates that the motor can continue to operate in its “forward” direction. The circuits can be arranged so the motor current can exceed the set point for a short period without reversing to accommodate spikes, but if the set point is exceeded for a set length of time, say a fraction of a second, the motor is reversed. Further, the current sense signal is provided to the maximum current set point comparator 52, which is conventionally done, to insure that the current being drawn by the motor does not exceed the maximum, even when if the operating set point in circuit 48 is adjusted upwardly.

The sensed current signal can be provided to the maximum current set point circuit along a line 54.

If the motor 28 requires or draws additional current to rotate the signs, because of conditions, such as increased bearing drag, wear or the like, the reversing set point in circuit 48 would be then adjusted upwardly so that the current level at which the motor would reverse would be raised. If the current that is sensed is greater than the set point for a short time, a signal is provided along a line 58 to the controller 38 to reverse the motor 28. The position sensor 44 indicates when the signs are back to a known position, and then the controller 38 would again drive the motor 28 forwardly. The current sensing circuit would again sense the current during this second try, and if the current exceeded the operating set point limit, the motor would again be reversed. A motor start up would then follow, and if the current still was too high, or greater than the set point, the motor reverse signal would be provided along the line 58. A counter 60 counts the number of reversing signals along the line 58. If the count equals three reversals in a row, the counter provides a signal along line 62 to the controller 38 to shut down the motor and stop the sign drive.

Once the obstruction or cause of reversal is cleared, the operation can resume. The current circuit 46 senses the current each time the motor 28 is started, again shortly after the “ramp up” of motor speed has occurred so that the motor is at its operating speed. An adjustment for the reversing set point limit is made each time as well.

If the reversing set point adjustment exceeds the maximum current limit of circuit 52, the reversing set point becomes the maximum current, and if the current senses a level above the maximum current the motor 28 will be shut down.

In FIG. 4, a graphical representation is shown of the current on the vertical line, versus time on the horizontal line. The motor currents are illustrated at 70A, 70B and 70C, for three cycles. The ramp up portion is shown at 72A, 72B and 72C, and at a time subsequent to the time that the current has leveled, a sampling is made, for example in line 70A an “X” and a vertical dotted line is placed at a time when the current sense by sensing circuit 46 would be made.

The line indicated at R1 is the set point current for normal operation shown by the motor currents 70A, 70B and 70C. If the current sense circuit indicates that the motor operating current is for example at a higher level as indicated by the dotted lines above the plots 70-7B, the reversing set point would be adjusted upwardly. If the motor operator current for a second drive cycle 70B reached a level indicated at 74, the set point would have been adjusted up to the dotted line representation shown at R₂ by the adjustable set point circuit 48. The maximum current line is shown at 78 in FIG. 4 and once the set point reached that current, it would not adjust any higher, but any current sense that was equal to the maximum current limit would cause a shutdown of the motor. If the motor operating current was less than the previous cycle as shown by dotted line 82 in the third cycle 70C, the set point current for reversal would be lowered, as indicated by line R₃ in FIG. 4, above the current cycle 70C.

The time between the shutting down of the motor 28 after one rotation, and the start of the ramp for another indicated by the double arrow 80 is the dwell time, and this can be adjusted as well.

When the motor 28 is energized to rotate the sign elements from face-to-face, they are ramped up to speed to prevent going over the maximum current limit. The motor drive current is increased at the start of each cycle from 0 to its full programmed set level, to get to the programmed operating current level in about 0.50 seconds. After that is done, approximately 0.10 seconds after reaching the operating speed, there is a sample of the load current. This is a value that is used for adjusting the set point for the current limit, before reversing occurs. It is important to note that the maximum current limit is always in effect, and will shut off the motor if that current is exceeded.

The motors are abruptly stopped, or turned off, and if desired, an electronic brake is activated to stop the motors.

It should be noted that exceeding the set point current or the maximum load current for a short period of time (approximately 0.1 second) will cause reversal. A very instantaneous spike or surge of current over the set point level will not cause reversal. The master controller 38 will start the motors in a forward direction, after a reversal, after a time delay of approximately 1-2 seconds. Then, if the set point current or the maximum current limit is exceeded in both the forward and in a subsequent reverse direction, the rotation stops immediately and a suitable warning is energized.

The maximum current limit is provided to protect the sign from physical damage and/or protect the control output stage from damage.

The signal sensed for controlling the torque adjustment does not have to be a pure current signal, but can be a torque sensing signal that operates, adjusts the motor reversing current set point. Various electrical signals can be provided from torque sensors to provide the adjustment.

Although the present invention has been described with reference to preferred embodiments, workers skilled in the art will recognize that changes may be made in form and detail without departing from the spirit and scope of the invention.

What is claimed is:

1. A drive for a rotating sign element comprising a reversible motor, a motor controller connected to the motor, the controller providing a drive current to the motor for normally energizing the motor at programmed intervals, a current sensing circuit for sensing the current drawn by the motor, an adjustable set point circuit receiving a signal from the current sensing circuit, said set point circuit providing a signal for reversing the motor when the set point is exceeded, said set point circuit being adjustable to change the set point in response to the signal from the current sensing circuit which is below the set point, so the set point exceeds the operating current sensed by a selected amount.

2. The drive of claim 1, wherein said set point is adjusted each time the motor is energized.

3. The drive of claim 1, wherein said motor controller ramps the motor up to a normal operating speed, and wherein the current sensing circuit samples the motor current subsequent to the motor reaching its normal operating speed.

4. The drive of claim 3, and a maximum current limit circuit, the current sensing circuit providing a current signal to the maximum current limit circuit to cause the motor to be stopped if the maximum current limit is exceeded.

5. A drive for a rotating sign element comprising a reversible drive motor, a motor controller connected to the drive motor, the motor controller providing an operating drive current to the drive motor for normally starting and driving the drive motor at spaced operating intervals, a sensing circuit for sensing the load on the drive motor during each operating interval, an adjustable set point circuit receiving a signal from the sensing circuit indicating the load on the motor during each operating interval, said set point circuit providing a reversing signal for reversing the drive motor when the reversing set point is exceeded, said set point circuit adjusting the reversing set point in response to each signal from the sensing circuit which is below an existing reversing set point, so the set point exceeds the load on the motor sensed by the sensing circuit by a selected amount, whether greater or less than the load on the motor during a previous operating cycle.

6. The drive of claim 5, wherein said set point is adjusted each time the motor is started.

7. The drive of claim 6, wherein said motor controller ramps the drive motor up to a normal operating speed when the drive motor starts, and wherein the sensing circuit determines the drive motor load subsequent to the drive motor reaching its normal operating speed.

8. The drive of claim 5, wherein the sensing circuit senses the operating drive current of the drive motor as an indication of the load on the motor.
